(19) United States
(12) Patent Application Publication
(10) Pub. No.: US 2011/0195158 A1
(43) Pub. Date: Aug. 11, 2011

(54) WILDLIFE NUTRITIONAL SUPPLEMENTATION AND METHODS FOR MAKING THE SAME

(76) Inventor: DAVID R. FUHR, New Boston, MO (US)

(21) Appl. No.: 13/022,872

(22) Filed: Feb. 8, 2011

Related U.S. Application Data
(60) Provisional application No. 61/303,127, filed on Feb. 10, 2010.

(51) Int. Cl. A23L 1/303; A23L 1/302; A23L 1/304

(52) U.S. Cl. 426/73; 426/72; 426/74; 426/648

(57) ABSTRACT

This invention relates to wildlife nutritional supplements providing enhanced immune-system bolstering effects. The invention further relates to wildlife nutritional supplements having improved stability and shelf-life and methods of making the same.

### CROSS-REFERENCE TO RELATED APPLICATIONS

This application is a nonprovisional application of U.S. Provisional Application No. 61/303,127, filed Feb. 10, 2010, which is herein incorporated by reference in its entirety.

### FIELD OF THE INVENTION

The invention pertains to the field of wildlife nutritional supplements. More particularly the invention pertains to a ruminant feed supplement with enhanced immune-system enhancement effects resulting from a product with enhanced stability. Methods for making the same are further disclosed for improving stability of the wildlife nutritional supplements and enhancing immune-system effects as a result of the same.

### BACKGROUND OF THE INVENTION

Supplementing the nutritional deficiencies in range rudiment animals, such as deer, elk and the like, is known in the art. Wildlife nutritional supplements are frequently placed near wildlife trails or other areas frequented by such wildlife. Wildlife nutritional supplements have gained increasing popularity as a means to enhance the health and life span of rudiment animals, such as for improved hunting and gaming. There remains a need for superior products and methods of making the same as a result of the reduction of wildlife habitat. For example, the expansion of human development leaves a noticeable impact on the health and vitality of wild ruminant animals often as a result of decreased food supply for such animals. Nutritional supplementation provides a means for improving the animals' reproduction, weight, antler size, and susceptibility to disease and parasites. Examples of commercially available brands and formulations are described in U.S. Pat. No. 6,572,903.

The macronutrients primarily accredited with impacting wildlife health and sustainability include calcium, phosphorus, potassium, sulfur, sodium, chloride and magnesium. The beneficial effects of these minerals are well known, such as: calcium aiding in the growth of bones, teeth and antlers and is important in the function of muscles and nerves; phosphorus aiding in the growth of bones, teeth and antlers, enhancing energy metabolism and enzymation as well as proper protein utilization; potassium is integral in the function of nerves, enzyme processes, as well as mineral and water balance; sulfur is an essential component of some proteins; sodium is vital to the function of muscles and nerves and also maintains water balance; chloride of sodium forms hydrochloric acid in the abomasums which aids in protein breakdown; and magnesium is an important component is almost all body processes.

There are also several trace minerals and vitamins known to be essential for maintaining a healthy wildlife, including for example the trace minerals manganese, copper, zinc, iodine, selenium, cobalt and iron, and the vitamins A, B, D, C and E. The well-known beneficial effects of these trace minerals include the following: manganese is essential for good bone development and feed utilization; copper is needed for blood and feed utilization; zinc provides an important influence on the rate of nutrient absorption; iodine is a vital component of the thyroid hormone which controls body temperature and rate of metabolism; selenium is needed for growth and reproduction and is also involved in enzymatic systems; cobalt is a necessary component of vitamin B12 and enzymes that digest feed; and iron is a critical component of red blood cells. There beneficial effects of the vitamins for use with wildlife range feed supplements are known to include the following: vitamin A is necessary to support growth, vision, reproduction, is involved in bone development and antler growth, and aids in controlling infections; vitamin D is necessary for the mineralization of bone development and antler growth and maintains proper functioning of muscles, nerves, blood clotting and cellular growth; vitamin C or ascorbic acid is important in the hydroxylation of collagen which in its absence is inadequately hydroxylated and produces the skin lesions and blood vessel weaknesses (such as those characteristic of the deficiency disease known as scurvy); and vitamin E is a component of the enzyme system, acting as an antioxidant at the cellular level as well as functioning in selenium metabolism.

Additional vitamins are desirable for supplementation formulations, often referred to as “B” series vitamins. “B” series vitamins may include the following groups: vitamin B-1 (thiamin), a catalyst in carbohydrate metabolism enabling carbohydrates to release energy while also serving as a natural insect repellent; vitamin B-2 (riboflavin), a critical cofactor or coenzyme in the metabolism of fats, carbohydrates and amino acids, the deficiency of which causes skin and corneal lesions; vitamin B-3, a critical element for cellular respiration and essential for the metabolism of carbohydrates and fats; vitamin B-5, required in the metabolism of fat, protein and carbohydrates; vitamin B-6 (pyridoxal), required in the synthesis and metabolism of protein and amino acids while also supporting the formation of red blood cells; vitamin B-12 (cobalamin), critical to normal nerve cell activity, DNA replication and the development of red blood cells; biotin (also known as vitamin H), a critical cofactor in the metabolism of carbohydrates, proteins and fats while also aiding in antler growth; and folic acid (tetrahydrofolate), important for the synthesis of nucleic acids.

The importance of the above-mentioned minerals, trace minerals and vitamins have been used in a variety of nutritional products to enhance the health and vitality of wildlife. Additionally, various products are available to increase insect repellency, improve palatability to enhance an animal's consumption of the product, and prevent parasitic and bacteria infections.

Despite the numerous health-related claims made by various wildlife supplement products, there remain numerous drawbacks to currently-available formulations as well as the manufacturing methods of making the same, demonstrating a need in the art for improved compositions and manufacturing methods.

Accordingly, it is an objective of the claimed invention to formulate improved supplementation compositions to improve the immune-system of ruminant wildlife.

A further object of the invention is to develop methods for making such improved nutritional supplementation compositions to enhance the composition's stability.

### BRIEF SUMMARY OF THE INVENTION

The present invention describes compositions and methods of making compositions for wildlife nutritional supplementation. The invention describes ruminant feed supplements capable of enhancing an animal's natural immune-system and providing enhanced repellency of ticks, mosquitoes, gnats, flies and other insects. The enhanced benefits of the wildlife nutritional supplement result from the novel methods of making the compositions resulting in enhanced stability of the product to provide the desirable effects, including for example immune-system enhancements.

### DETAILED DESCRIPTION OF THE PREFERRED EMBODIMENT

The embodiments of this invention are not limited to particular compositions and methods for making the compositions as they can vary as are understood by skilled artisans. It is further to be understood that all terminology used herein is for the purpose of describing particular embodiments only, and is not intended to be limiting in any manner or scope. For example, as used in this specification and the appended claims, the singular forms “a,” “an” and “the” can include plural referents unless the content clearly indicates otherwise. It should also be noted that the term “or” is generally employed in its sense including “and/or” unless the content clearly dictates otherwise. Further, all units, prefixes, and symbols may be denoted in their SI accepted form. Numeric ranges recited within the specification are inclusive of the numbers defining the range and include each integer within the defined range.

It is understood that wildlife suffering from mineral, trace mineral and vitamin deficiencies benefit from ongoing, consistent intake of supplements, rather than sporadic consumption. However, often supplements are not stable for the ongoing consumption of the animals, requiring the compositions to be frequently distributed to provide adequate supply. This is the result of a composition becoming ineffective upon prolonged exposure to various environmental conditions and based on the shelf-life of the product. This may further be the result of a composition's inferior formulation exposing the supplementation elements to oxidative or other degradative effects, resulting in products with a shortened shelf-life and inability to provide the desired therapeutic benefits. The methods and compositions according to the present invention overcome this shortfall of the prior art, providing wildlife supplements that are intended for ongoing, consistent intake by animals. Further, the compositions are made according to methods providing enhanced stability to ensure that elements formulated in a supplementation composition are effective in achieving its intended nutritive effects. The compositions and methods of making the compositions according to the invention overcome a significant deficit found in the prior art at the time the present invention was made, demonstrating a solution to a market demand that was not obvious to those of ordinary skill in the pertinent art.

According to an embodiment of the invention, the wildlife nutritional supplement compositions are made according to novel formulation methods. Although not intended to be limited according to a single description of the formulation methods and/or theories for its unexpected formulation benefits, the formulation methods are blended in a manner providing synergistic reactions between and among the compositions' ingredients. The synergistic reactions, including the improved effects of the vitamin ingredients, provide an enhanced wildlife nutritional supplement. The beneficial results include wildlife supplementation compositions providing enhanced nutritive benefits, such as immune system improvements. These results may be demonstrated, for example, through improved repellency of ticks, mosquitoes, gnats, flies and other insects, indicative of improved effectiveness of an administered nutritional supplementation according to the invention.

According to one embodiment, the composition is made by blending the following ingredients: macrominerals, trace minerals and vitamins. According to embodiments of the invention, macrominerals may include for example calcium, phosphorus, potassium, sulfur, sodium, chloride, magnesium and combinations of the same. Macrominerals may be provided in a variety of commercially available and known formulations, including in salt and other forms, which are known to a person having ordinary skill in the art to which the invention pertains. According to an embodiment of the invention, trace minerals may include manganese, copper, zinc, iodine, selenium, cobalt, iron and combinations of the same. According to the various embodiments of the invention, trade minerals may be provided in various forms as may be commercially available and known to a person having ordinary skill in the art to which the invention pertains, including for example salt and other forms.

According to a further embodiment of the invention, vitamins may include Vitamins A, D, E, B1, B2, B3, B5, B6, B7, B9, B12, C, K, complex vitamins and other essential and non-essential vitamins and combinations of the same in various known forms. According to the invention, dietary nutrients including macrominerals, trace minerals and vitamins may further include fatty acids, amino acids, dietary minerals and other elements as may be ascertained by a skilled artisan as providing benefit for wildlife supplementation and therefore may be utilized according to the methods and compositions of the present invention. According to a further embodiment of the invention, the various dietary nutrients may include all organic formulations.

According to one embodiment, the methods of making a wildlife nutritional supplement include the addition of one or more additive mixtures to a macromineral formulation. According to a preferred embodiment, a two-part additive mixture is added to a macromineral formulation. According to embodiments of the invention, the two-part additive mixture may comprise a first additive mixture providing desired amounts of calcium, copper, iron, magnesium, zinc and dextrose. The two-part additive mixture may further comprise a second additive mixture providing desired amounts of vitamins, iodine and dextrose. Alternatively, according to the invention, the two-part additive mixture may comprise a first additive mixture providing desired amounts of vitamins, iodine and dextrose, with a second additive mixture providing desired amounts of calcium, copper, iron, magnesium, zinc and dextrose.

According to a preferred embodiment the additive mixtures are continuously blended with the macromineral source. According to a still further preferred embodiment the additive mixtures are continuously blended with the macromineral source for at least about 5 minutes, preferably at least about 10 minutes, and more preferably for at least about 15 minutes. One skilled in the art to which the invention pertains will ascertain means by which the blending described herein may occur. For example, a paddle-blender may be used according to the invention to first blend the macrominerals.

According to a preferred embodiment, the heaviest component of the supplementation formulation, the macrominerals, are first blended to ensure there is an even dispersement of the macromineral components. Preferably, there is a homogenous mixture of the macromineral components. According to a preferred embodiment, one of the additive mixtures is next added to the blended macrominerals and continuously blended before the addition of the second additive mixture. According to an embodiment the additive mixtures may be either a mineral additive (referred to as either a micromineral or trace mineral) or vitamin additive. Preferably, the macrominerals and two additive mixtures are continuously blended for at least about 15 minutes.

Although not intending to be limited according to a particular theory for the unexpected and synergistic results obtained according to the invention, the results are hypothesized to result from the blending of the supplement's ingredients as described herein. According to the invention, the final blending of a multi-part additive mixture maintains separation of essential elements and vitamins prior to formulation. It is demonstrated that the separation of certain vitamins from elements having a potentially degradative or oxidative effect on the supplementation composition results in unexpectedly enhanced performance of the vitamins, including synergistic results as shown by the efficacy of the animal nutritional supplementation.

According to one embodiment of the invention, the separation of additive mixtures comprising the oxidative elements, such as copper, from vitamins, such as B series vitamins, prevents the onset of decomposition of the desired vitamins within the formulations. According to a theory of the invention, elemental minerals such as copper may catalyze the oxidation of vitamins, such as for example, vitamins B and/or C. Further, the elemental minerals may accelerate the decomposition of the vitamins if maintained in the formulation for extended periods of time. Therefore, according to the invention, to achieve a nutritional supplementation composition having enhanced effects, the addition of the minerals and vitamins are made from separately stored and manufactured additive mixtures.

According to the invention, the blending of at least two additive mixtures with a macromineral formulation promotes the stability and shelf-life of the wildlife supplementation composition. According to a further embodiment of the invention, blending techniques described herein promote the synergistic reaction of “B” series vitamins. Without the potentially harmful effects of any oxidative minerals, the vitamin B elements of a supplementation formulation are able to provide the desired result of enhanced immune system protection, through the repellency of ticks, gnats and other insects. The results observed for protecting wildlife from such insects is synergistic in comparison to a product that does not follow the blending techniques according to the invention.

Accordingly, products administered to free choice fed ruminants and other animals provide sufficient amounts of the nutritive value provided by a composition in order to effectuate the desired nutritional outcomes. This unexpected result of enhancing a product's stability to promote the desired nutritional outcomes in wildlife unexpectedly results from the modification of the formulation methods. It was not obvious to one skilled in the art that the manufacture or purchase of separate additive mixtures for minerals and vitamins would enhance the nutritive value and effects in wildlife, as well as provide a composition having an improved shelf-life due to enhanced product stability. According to an embodiment of the invention, the compositions providing such enhanced nutritive value and effects have a shelf-life of at least two years while maintaining potency and efficacy. These beneficial effects unexpectedly result from the prevention of degradation and oxidation of vitamins and other components found in the supplementation composition according to the invention.

According to an embodiment of the invention, the wildlife nutritional supplement composition provides enhanced formulation due to the methods of making the same. This provides unexpected and superior results over prior art supplementation compositions, which are limited by their formulations which combine all of the minerals and nutrients with vitamins. As a result, such products do not provide compositions having an improved and uniform blend of products, products with sufficient shelf-life, nor products demonstrating a synergistic reaction of vitamins contained in the formulation. As described according to the present invention, the formulation and methods of making the same provide enhanced supplementation compositions having improved immune system benefits and nutritive benefits as a result of the preferred blending methods described herein with regard to the core minerals and vitamins.

According to an embodiment of the invention, the wildlife nutritional supplement composition includes decreased levels of calcium and phosphorus (compared to various commercially-available formulations), increased levels of sodium and salts to create a more palatable product to animals to promote consumption, and “B” and “C” series vitamins to maintain the overall health of ruminant animals. The supplement composition may comprise levels of calcium below 20% and phosphorus below 10%, preferably amounts ranging between 5-19.6% calcium and 4%-9.8% phosphorus. According to a preferred embodiment, the inclusion of “B” series vitamins provides vitamin sources previously believed to be obtainable by wildlife through natural resources. However, such ideal environmental conditions and natural resources are not always present, particularly in arid, dry regions. According to a further embodiment of the invention, the nutritional supplement compositions provides “B” vitamin supplementation necessary to protect wildlife from insect bites, such as ticks, and enhances the animal's immune system strength.

According to a further embodiment of the invention, the compositions include anthelminthic (also referred to as de-worming) agents. According to a preferred embodiment the anthelminthic agent is fenbendazole. The benefits of including anthelminthic agents are effective for treating and prophylactically preventing infectious agents such as the various species of gastrointestinal nematodes known to infect wildlife, such as white-tailed deer and livestock. See e.g., Prestwood, A. K., et al., Gastrointestinal nematodes, p. 318-350 (1981); Davidson, et al., Diseases and parasites of white-tailed deer. Tall Timbers Res. Sta. Misc. Pub. 7; and Schultz, et al., Efficacy of fenbendazole against gastrointestinal nematodes in white-tailed deer. Journal of Range Management. 46:240-244 (1993).

According to a further embodiment of the invention, the compositions include antibiotic agents. Inclusion of an antibiotic may provide similar benefits to the periodic inducement into a human diet, such that the animals are exposed to prophylactic and regulating effects of antibiotics. According to a preferred embodiment the antibiotic agent is oxytetracycline or similar members of the tetracycline class of antibiotics. According to further embodiments of the invention, additional classes of antibiotics may be included in the formulations as may be readily ascertained by one of ordinary skill in the art to which the invention pertains. The inclusion of an antibiotic in the nutritional supplementation composition allows the animal to use what it needs and discard the remaining antibiotic through its natural waste system.

The wildlife nutritional supplement composition according to the invention may be formulated into a granular or block form. According to an alternative embodiment the wildlife nutritional supplement composition according to the invention may be formulated into a liquid medium.

According to an embodiment of the invention, the nutritive supplementation composition may comprise from about 5-15% calcium, from about 1-10% phosphorus, less than 5% potassium, from about 1-5% sulfur, from about 10-40% sodium and less than 5% magnesium. According to a further embodiment, the composition may further comprise from about 800-1,600 PPM iron, from about 10-100 PPM copper, from about 60-150 PPM manganese, from about 20-100 PPM zinc, from about 1-50 PPM cobalt, from about 1-50 PPM selenium, from about 1-50 PPM iodine, from about 10,000-100,000 IU/LB Vitamin A, from about 10,000-100,000 IU/LB Vitamin D, from about 20-10,000 IU/LB Vitamin E, from about 40-180 MG/LB biotin and from about 40-100 MG/LB ascorbic acid.

According to an alternative embodiment of the invention, the nutritive supplementation formulation may comprise from about 7.5-8.5% calcium, about 3.5% phosphorus, about 32-37% salt, at least one “B” series vitamin is selected from a group consisting of pantothenic acid, folic acid, riboflavin, niacin, thiamine, cobalamin, and pyridoxine hydrochloride, about 16-19% sodium, about 0.15% magnesium, about 0.15% potassium, about 2.5% sulfur, about 1,200 PPM iron, about 20 PPM copper, about 105 PPM manganese, about 45 PPM zinc, about 5 PPM cobalt, about 1 PPM selenium, about 1 PPM iodine, about 50,000 IU/LB Vitamin A, about 20,000 IU/LB Vitamin D, about 50 IU/LB Vitamin E, about 134 MG/LB biotin, about 60 MG/LB ascorbic acid, oxytetracycline and fenbendazole.

Alternate embodiments may comprise from about 17-18% calcium, about 9% phosphorus, about 11-12% salt, at least one “B” series vitamin selected from a group consisting of pantothenic acid, folic acid, riboflavin, niacin, thiamine, cobalamin, and pyridoxine hydrochloride, about 10-11% sodium, about 3.7% magnesium, about 3.7% potassium, about 0.0037% sulfur, about 1,666 PPM iron, about 185 PPM copper, about 60 PPM manganese, about 1,388 PPM zinc, about 2 PPM cobalt, about 0.57 PPM selenium, about 13 PPM iodine, about 50,000 IU/LB Vitamin A, about 20,000 IU/LB Vitamin D, about 50 IU/LB Vitamin E, about 134 MG/LB biotin, about 60 MG/LB ascorbic acid, oxytetracycline and fenbendazole.

According to an embodiment, the formulation methods and compositions according to the invention provide an enhanced wildlife nutritional supplement that retains stability to provide the complete intended supplementation to such animal. Further, according to an embodiment, the formulation methods and compositions according to the invention described herein provide enhanced immune function of wildlife animals consuming the supplementation compositions. According to one embodiment, the supplementation compositions provide treatment and/or prophylaxis from various infectious agents, including for example species of gastrointestinal nematodes.

Unless defined otherwise, all technical and scientific terms used herein have the same meaning as commonly understood by one of ordinary skill in the art to which embodiments of the invention pertain. Many methods and materials similar, modified, or equivalent to those described herein can be used in the practice of the embodiments of the present invention without undue experimentation, the preferred materials and methods are described herein. In describing and claiming the embodiments of the present invention, the following terminology is used in accordance with the definitions set out below.

The term “about,” as used herein, refers to variation in the numerical quantity that can occur, for example, through typical measuring and liquid handling procedures used for making concentrates or use solutions in the real world; through inadvertent error in these procedures; through differences in the manufacture, source, or purity of the ingredients used to make the compositions or carry out the methods; and the like. The term “about” also encompasses amounts that differ due to different equilibrium conditions for a composition resulting from a particular initial mixture. Whether or not modified by the term “about”, the claims include equivalents to the quantities referred and variations in the numerical quantities that can occur, for example, through typical measuring and liquid handling procedures used for making concentrates or use solutions in the real world; through inadvertent error in these procedures; through differences in the manufacture, source, or purity of the ingredients used to make the compositions or carry out the methods; and the like.

The term “weight percent,” “wt-%,” “percent by weight,” “% by weight,” and variations thereof, as used herein, refer to the concentration of a substance as the weight of that substance divided by the total weight of the composition and multiplied by 100. It is understood that, as used here, “percent,” “%,” and the like are intended to be synonymous with “weight percent,” “wt-%,” etc.

All publications and patent applications in this specification are indicative of the level of ordinary skill in the art to which this invention pertains. All publications and patent applications are herein incorporated by reference to the same extent as if each individual publication or patent application was specifically and individually indicated by reference.

### EXAMPLES

Embodiments of the present invention are further defined in the following non-limiting Examples. It should be understood that these Examples, while indicating certain embodiments of the invention, are given by way of illustration only. From the above discussion and these Examples, one skilled in the art can ascertain the essential characteristics of this invention, and without departing from the spirit and scope thereof, can make various changes and modifications of the embodiments of the invention to adapt it to various usages and conditions. Thus, various modifications of the embodiments of the invention, in addition to those shown and described herein, will be apparent to those skilled in the art from the foregoing description. Such modifications are also intended to fall within the scope of the appended claims.

### Example 1

Studies analyzing the effectiveness of these approaches reveal substantial and unexpected advantages as described herein for example. It is known that calcium and phosphorus are essential components in wildlife nutritional supplements, often present in amounts ranging between 5-19.6% calcium and a minimum of 4% phosphorus in order to provide the nutritionally beneficial effects. References have shown that decreasing the concentration of these minerals promotes the intake or consumption of a supplementation product. For example, a formulation with calcium and phosphorus concentrations below 5-19.6% and 4%, respectively, results in increased total consumption by wildlife due to palatability and other desirable attributes through the addition of sodium and salt to act as an attractant for wildlife. This results in increased regular consumption and year-round usage by wildlife providing an overall greater intake of calcium and phosphorus than was previously achieved by products comprising greater concentrations of the same minerals. The reduction of calcium and phosphate further enables the addition of “B” series vitamins to the formulation.

However, the approach to formulating supplementation products with decreased levels of calcium and phosphorus, in combination with enhanced use of sodium and salts, will only result in improved animal health to the extent the product's formulation is stable and compatible with its formulation components. As described according to the methods of making the claimed nutritional supplementation composition, formulations separating the micromineral and vitamin additives result in a product having increased shelf-life. Accordingly, wildlife are provided a product with desirable nutritive content that remains stable to provide the intended benefits.

### Example 2

A vitamin premix, containing iodine, for the nutritional supplement according to the invention is provided (on a per gram basis):

| | | |
|---|---|---|
| Palmitate | 50,000 | IU |
| Cholecalciferol | 20,000 | IU |
| dl-alpha-tocopheryl acetate | 50 | IU |
| Biotin | 0.3 | mg |
| Folic Acid | 0.4 | mg |
| Niacin | 20 | mg |
| Calcium d-Pantothenate | 10 | mg |
| Thiamin mononitrate | 1.5 | mg |
| Cyanocobalamin | 8 | mcg |
| Riboflavin | 1.7 | mg |
| Pyridoxine hydrochloride | 2 | mg |
| Ascorbic acid | 60 | mg |
| Potassium iodide | 0.15 | mg |

| | |
|---|---|
| Dextrose | Q.S. gram |

The vitamin premix formulation provides a 24 month shelf-life for the nutrients in the premix formulation.

### Example 3

A mineral premix, containing the copper content for the nutritional supplement according to the invention is provided (on a per gram basis):

| | | |
|---|---|---|
| Calcium carbonate | 0.45 | mg |
| Copper sulfate | 0.03 | mg |
| Iron | 0.003 | mg |
| Magnesium oxide | 0.07 | mg |
| Zinc oxide | 0.003 | mg |

| | |
|---|---|
| Dextrose | Q.S. gram |

The mineral premix formulation provides a 24 month shelf-life for the nutrients in the premix formulation.

What is claimed is:

1. A method for making a nutritional supplementation comprising:
blending a macromineral composition with a first additive composition to form a first nutritional supplementation composition; and
blending into said first nutritional supplementation composition a second additive composition, wherein the separation of said first additive composition and said second additive composition prevents degradation and oxidation of the nutritional supplementation components.

2. The method of claim 1 wherein said first additive composition is a trace mineral composition and said second additive composition is a vitamin composition.

3. The method of claim 1 wherein said first additive composition is a vitamin composition and said second additive composition is a trace mineral composition.

4. The method of claim 1 wherein said blending is continuous.

5. The method of claim 1 wherein said blending continues for at least ten minutes.

6. The method of claim 2 wherein said trace mineral composition comprises minerals selected from the group consisting of manganese, copper, zinc, iodine, selenium, cobalt, iron and combinations of the same, and wherein said vitamin composition comprises vitamins selected from the group consisting of Vitamins A, D, E, B1, B2, B3, B5, B6, B7, B9, B12, C, K, complex vitamins and combinations of the same.

7. The method of claim 3 wherein said trace mineral composition comprises minerals selected from the group consisting of manganese, copper, zinc, iodine, selenium, cobalt, iron and combinations of the same, and wherein said vitamin composition comprises vitamins selected from the group consisting of vitamins A, D, E, B1, B2, B3, B5, B6, B7, B9, B12, C, K, complex vitamins and combinations of the same.

8. The method of claim 3 wherein said macromineral composition comprises macrominerals selected from the group consisting of calcium, phosphorus, potassium, sulfur, sodium, chloride, magnesium and combinations of the same.

9. The nutritional supplementation composition produced by the method of claim 1.

10. The composition of claim 9 wherein said additive composition is a trace mineral composition and said second additive composition is a vitamin composition; wherein said trace mineral composition comprises minerals selected from the group consisting of manganese, copper, zinc, iodine, selenium, cobalt, iron and combinations of the same, and wherein said vitamin composition comprises vitamins selected from the group consisting of Vitamins A, D, E, B1, B2, B3, B5, B6, B7, B9, B12, C, K, complex vitamins and combinations of the same.

11. The composition of claim 9 wherein said macromineral composition comprises macrominerals selected from the group consisting of calcium, phosphorus, potassium, sulfur, sodium, chloride, magnesium and combinations of the same.

12. The composition of claim 9 comprising from about 5-15% calcium, from about 1-4% phosphorus, less than 5% potassium, from about 1-5% sulfur, from about 10-40% sodium and less than 5% magnesium.

13. The composition of claim 12 comprising from about 800-1,600 PPM iron, from about 10-100 PPM copper, from about 60-150 PPM manganese, from about 20-100 PPM zinc, from about 1-50 PPM cobalt, from about 1-50 PPM selenium, from about 1-50 PPM iodine, from about 10,000-100,000 IU/LB Vitamin A, from about 10,000-100,000 IU/LB Vitamin D, from about 20-10,000 IU/LB Vitamin E, from about 40-180 MG/LB biotin, from about 40-100 MG/LB ascorbic acid and at least one B series vitamin.

14. The composition of claim 13 wherein said B series vitamin is selected from the group consisting of pantothenic acid, folic acid, riboflavin, niacin, thiamine, cobalamin, pyridoxine hydrochloride and combinations of the same.

15. The composition of claim 9 further comprising an antibiotic.

16. The composition of claim 9 further comprising an anthelminthic component.

17. A nutritional supplementation composition comprising: from about 5-15% calcium, from about 1-4% phosphorus, less than 5% potassium, from about 1-5% sulfur, from about 10-40% sodium, less than 5% magnesium, from about 800-1,600 PPM iron, from about 10-100 PPM copper, from about 60-150 PPM manganese, from about 20-100 PPM zinc, from about 1-50 PPM cobalt, from about 1-50 PPM selenium, from about 1-50 PPM iodine, from about 10,000-100,000 IU/LB Vitamin A, from about 10,000-100,000 IU/LB Vitamin D, from about 20-10,000 IU/LB Vitamin E, from about 40-180 MG/LB biotin, from about 40-100 MG/LB ascorbic acid, and at least one B series vitamin, wherein said B series vitamin provides synergistic enhancement of a natural immune system of an animal.

18. The composition of claim 17 wherein said B series vitamin is selected from the group consisting of pantothenic acid, folic acid, riboflavin, niacin, thiamine, cobalamin, pyridoxine hydrochloride and combinations of the same.
